(19) United States
(12) Patent Application Publication
(10) Pub. No.: US 2026/0025840 A1
(43) Pub. Date: Jan. 22, 2026

(54) CAPABILITY DETERMINATION OF INTERNET OF THINGS DEVICES

(71) Applicant: Lenovo (United States) Inc., Morrisville, NC (US)

(72) Inventors: Thomas Ralph Luetzenkirchen, Taufkirchen (DE); Genadi Velev, Darmstadt (DE); Andreas Kunz, Ladenburg (DE); Hyung-Nam Choi, Ottobrunn (DE)

(21) Appl. No.: 19/343,836

(22) Filed: Sep. 29, 2025

(51) Int. Cl. H04W 72/51

(52) U.S. Cl. CPC H04W 72/51

(57) ABSTRACT

A network entity may include at least one memory and at least one processor coupled with the at least one memory. The processor may be configured to cause the network entity to transmit an inventory request message to an internet of things (IoT) device, wherein the inventory request message includes a command type, and to monitor for an inventory report message from the IoT device based at least in part on the transmitted inventory request message. The inventory report message may include an indication that is indicative of whether the command type is supported by the IoT device. The processor may be further configured to determine a capability of the IoT device in response to a reception of the inventory report message based at least in part on the monitoring, or based at least in part on an absence of the inventory report message from the IoT device.

### TECHNICAL FIELD

The present disclosure relates to wireless communications, and more specifically to capability determination of internet of things (IoT) devices in a wireless communications system.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, including in the claims, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Various aspects of the present disclosure relate to wireless communications, including improved network entities, processors, and methods for capability determination of IoT devices in a wireless communications system.

A network entity is described. The network entity may comprise at least one memory and at least one processor coupled with the at least one memory and configured to cause the network entity to: transmit an inventory request message to an internet of things (IoT) device, wherein the inventory request message comprises a command type; monitor for an inventory report message from the IoT device based at least in part on the transmitted inventory request message, wherein the inventory report message comprises an indication that is indicative of whether the command type is supported by the IoT device; and determine a capability of the IoT device in response to a reception of the inventory report message based at least in part on the monitoring or an absence of the inventory report message from the IoT device based at least in part on the monitoring.

A processor (e.g., a standalone chipset or a component of a network entity) is described. The processor may be configured to cause the network entity to: transmit an inventory request message to an IoT device, wherein the inventory request message comprises a command type; monitor for an inventory response message from the IoT device based at least in part on the transmitted inventory request message, wherein the inventory report message comprises an indication that is indicative of whether the command type is supported by the IoT device; and determine a capability of the IoT device in response to a reception of the inventory report message based at least in part on the monitoring or an absence of the inventory report message from the IoT device based at least in part on the monitoring.

A method performed or performable by a network entity is described. The method may comprise transmitting an inventory request message to an IoT device, wherein the inventory request message comprises a command type; monitoring for an inventory report message from the IoT device based at least in part on the transmitted inventory request message, wherein the inventory report message comprises an indication that is indicative of whether the command type is supported by the IoT device; and determining a capability of the IoT device in response to a reception of the inventory report message based at least in part on the monitoring or an absence of the inventory report message from the IoT device based at least in part on the monitoring.

An IoT device is described. The IoT device may comprise at least one memory and at least one processor coupled with the at least one memory and configured to cause the IoT device to: receive an inventory request message, wherein the inventory request message comprises a command type; determine whether the IoT device supports the command type; and determine whether to transmit an inventory report message in response to the received inventory request message and based at least in part on whether the IoT device supports the command type.

A processor (e.g., a standalone chipset or a component of an IoT device) is described. The processor may be configured to cause the IoT device to: receive an inventory request message, wherein the inventory request message comprises a command type; determine whether the IoT device supports the command type; and determine whether to transmit an inventory report message in response to the received inventory request message and based at least in part on whether the IoT device supports the command type.

A method performed or performable by an IoT device is described. The method may comprise receiving an inventory request message, wherein the inventory request message comprises a command type; determining whether the IoT device supports the command type; and determining whether to transmit an inventory report message in response to the received inventory request message and based at least in part on whether the IoT device supports the command type.

A radio access network (RAN) device is described. The RAN device (e.g., a base station, a UE reader, etc.) may comprise at least one memory and at least one processor coupled with the at least one memory and configured to cause the RAN device to: generate a paging message comprising a command type; and transmit the paging message to an IoT device.

A processor (e.g., a standalone chipset or a component of a RAN device) is described. The processor may be configured to cause the RAN device to: generate a paging message comprising a command type; and transmit the paging message to an IoT device.

A method performed or performable by a RAN device is described. The method may comprise generating a paging message comprising a command type; and transmitting the paging message to an IoT device.

### BRIEF DESCRIPTION OF THE DRAWINGS

FIG. 1 illustrates an example of a wireless communications system in accordance with aspects of the present disclosure.

FIG. 2 illustrates an example of a command procedure in accordance with aspects of the present disclosure.

FIG. 3 illustrates an example of a UE in accordance with aspects of the present disclosure.

FIG. 4 illustrates an example of a processor in accordance with aspects of the present disclosure.

FIG. 5 illustrates an example of a NE in accordance with aspects of the present disclosure.

FIG. 6 illustrates a flowchart of a method performed by a network entity in accordance with aspects of the present disclosure.

FIG. 7 illustrates a flowchart of a method performed by an IoT device in accordance with aspects of the present disclosure.

FIG. 8 illustrates a flowchart of a method performed by a RAN in accordance with aspects of the present disclosure.

### DETAILED DESCRIPTION

Some wireless communication systems, including those involving one or more network entities, readers, and internet of things (IoT) devices, may support multi-phase procedures to enable inventory and command exchanges. For example, an inventory phase may be used to identify or register an IoT device, followed by a command phase in which a network entity may transmit a read or write command to the IoT device. The IoT device may be required to process the received command, perform security validation, and generate a response message. If the IoT device does not support the requested command type, or if parameters within the command are invalid, the device may transmit a rejection message indicating that the command cannot be executed. Even when a command is not supported, the IoT device completes all steps of the procedure, including receiving the command, validating its integrity, generating a rejection message, applying message protection, and transmitting the response over an uplink channel. Likewise, the network entity allocates resources and transmit a corresponding downlink message to initiate the exchange. This can result in extra signaling overhead and unnecessary energy consumption, especially for constrained IoT devices that are unable to support certain commands. As additional command types are introduced, the frequency of command rejection is expected to increase, raising concerns about signaling efficiency, interoperability, and long-term support for devices with limited functionality.

The techniques described herein provide significant advantages by reducing unnecessary device-to-network signaling when an IoT device does not support a specific command, thereby conserving energy and extending device lifetime. For example, by transmitting an inventory request message to an IoT device having a command type, the IoT device can determine whether it is compatible with the command type and transmit information corresponding to the compatibility. By enabling early filtering of incompatible devices (e.g., by determining compatibility with a command request) and avoiding transmission of unsupported commands, certain techniques improve spectrum efficiency, enhance compatibility across heterogeneous IoT deployments, and provide a scalable framework for supporting future command types without overburdening legacy devices.

Aspects of the present disclosure are described in the context of a wireless communications system.

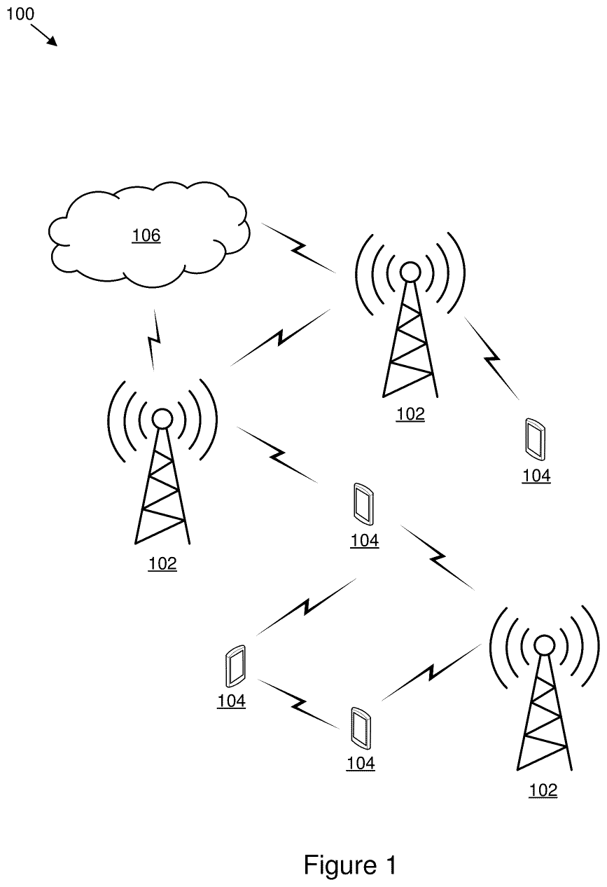

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20 and ISO18000-6C UHF RFID. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), an Ambient IoT device reader, an RFID reader, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with an NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Ambient IoT (AIoT) device (e.g., this may have fewer or more components than a standard UE), an RFID tag, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, N6 or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHZ-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Certain UEs 104 (e.g., that support reader functionality) may be and/or may communicate with an internet of things (IoT) or ambient IoT (AIOT) device. Various commands, such as inventory report, read, and/or write may be supported by the device. In one example, if an AIoT device does not support a read request and/or a write request command, or if parameters in commands are invalid, then the AIoT Device may reject the command. In another example, an AIoT device may reject a read command using a read command reject AIoT non-access stratum (NAS) message type and may reject a write command using a write command reject AIoT NAS message type. One example of AIoT NAS message types is shown in Table 1.

TABLE 1
AIoT Message Types for AIoT NAS

| Bits | | | | | | | | |
|---|---|---|---|---|---|---|---|---|
| 8 | 7 | 6 | 5 | 4 | 3 | 2 | 1 | AIoT Message Type |
| 0 | 1 | 0 | 0 | 0 | 0 | 0 | 1 | Inventory report |
| 0 | 1 | 0 | 0 | 0 | 0 | 1 | 0 | Read command |
| 0 | 1 | 0 | 0 | 0 | 0 | 1 | 1 | Read complete |
| 0 | 1 | 0 | 0 | 0 | 1 | 0 | 0 | Read command reject |
| 0 | 1 | 0 | 0 | 0 | 1 | 0 | 1 | Write command |
| 0 | 0 | 0 | 0 | 0 | 1 | 1 | 0 | Write complete |
| 0 | 0 | 0 | 0 | 0 | 1 | 1 | 1 | Write command reject |
| 0 | 0 | 0 | 0 | 1 | 0 | 0 | 0 | Permanent disable command |
| 0 | 0 | 0 | 0 | 1 | 0 | 0 | 1 | Permanent disable complete |

In some configurations, if a specific AIoT device does not support a read or write command, it still may complete all phases of a procedure. Completing all phases of a procedure may include receiving a command message, performing security validation, generating a response message (e.g., read command reject or write command reject AIoT NAS message), applying message protection, and/or transmitting the response over an air interface. Likewise, an AIoT reader may generate a downlink RF signal and allocate uplink resources to enable the AIoT device to respond to the command request.

In various configurations, additional AIoT command types and message formats may be used. With an increase in AIoT command types, a likelihood of command rejection may increase, particularly with older AIoT devices. Older AIoT devices may have limited functionality, but should be supported even if there is an increase in AIoT command types. In certain configurations, an older AIoT device may be able to reject a command if it cannot interpret or validate it.

Various methods may be used to reduce a number of Reader-to-Device (R2D) and Device-to-Reader (D2R) messages if an AIoT device does not support a specific command from a network, thereby improving signaling efficiency and conserving device energy. Certain AIoT architectures may not support mechanisms to proactively reduce a number of device and network interactions if an AIoT device does not support a specific command request from the network. This may be a huge limitation if a diversity of AIoT devices increases and legacy devices with limited functionality continue to coexist with newer more capable ones. Furthermore, it may be challenging for an older AIoT device to correctly reject a command it cannot interpret or validate. To overcome these challenges, there may be enhancements to reduce unnecessary signaling, improve AIoT device compatibility filtering, and provide support for rejecting unknown commands. One system may have the following improvements: preview driven gating of phase 1 and 2 resources allowing the network to avoid scheduling unnecessary command signaling and RF resource allocation, provide support for early filtering of incompatible devices, reduce AIoT device-side processing of unsupported NAS messages to conserve energy, support a legacy AIoT device to ignore unknown command requests defined in future releases, and/or for a UE reader, reduce UE-side signaling and processing for increased spectrum efficiency and extended UE battery life.

In one configuration, an inventory request message may be enhanced to include command preview profile information that specifies an anticipated command type (e.g., read and/or write command) and/or a required compatibility level. Upon receiving the inventory request message, an AIoT device may evaluate the command preview profile relative to its supported capabilities. If the AIoT device is compatible, the AIoT device may respond with an inventory report message. If the AIoT device is incompatible, the AIoT device may not send an inventory report message. At an AIoT function (AIoTF), an absence of an inventory report message for an AIoT device may interpreted as the AIoT being incompatible with the anticipated command. Consequently, the AIoTF may not initiate a command request phase for that AIoT device. Accordingly, this mechanism may avoid transmitting unsupported commands, reduce signaling overhead, and conserve energy for both the AIoT device and the network.

In another configuration, instead of an absence of an inventory report message from an AIoT device, the AIoT device may always send an inventory report message, but may include a compliance indicator having a value (e.g., bit) indication support or not support for an anticipated command type. In some examples, the inventory report message may include an error cause code (e.g., an unsupported command type, an insufficient capability, etc.). The AIoTF may use this compliance information to filter out incompatible AIoT devices before initiating a command request phase. Accordingly, there may be explicit feedback for network analytics and troubleshooting while still avoiding unnecessary command signaling.

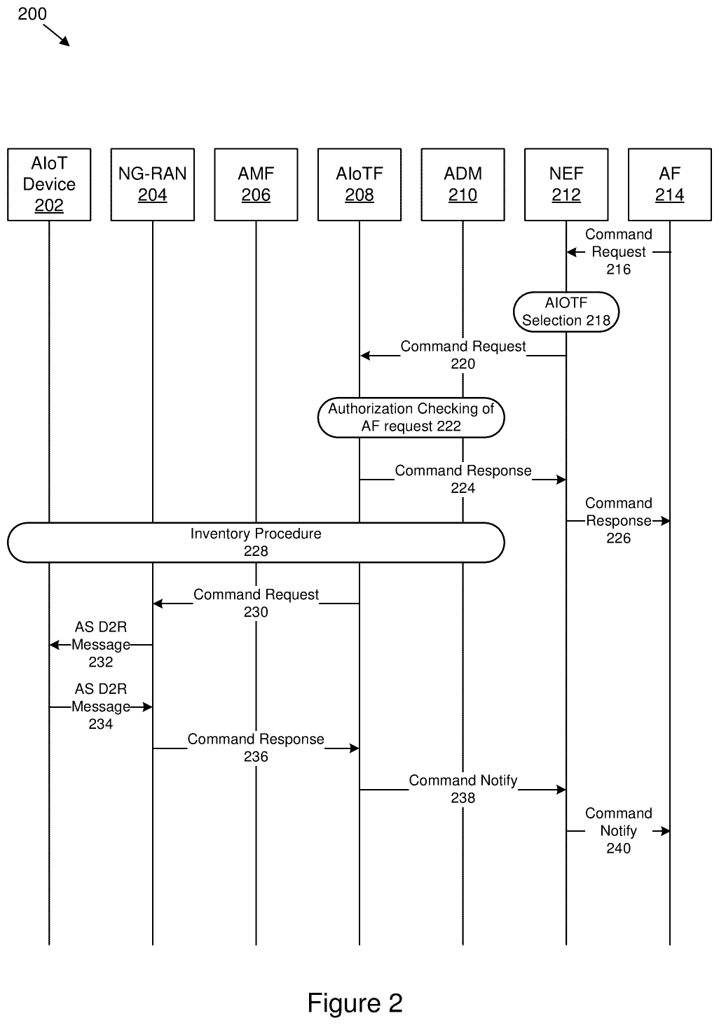

FIG. 2 illustrates an example of a command procedure 200 in accordance with aspects of the present disclosure. In some examples, the command procedure 200 implements or is implemented by aspects of the wireless communications system 100. For example, the command procedure 200 may implement or be implemented by one or more devices and/or entities (e.g., UEs, NEs, network entities, or other devices or entities), including: an AIoT device 202, a next generation (NG)-RAN 204, an AMF 206, an AIoTF 208, an ambient IoT data management function (ADM) 210, a network exposure function (NEF) 212, and/or an application function (AF) 214. The command procedure 200 is directed to messages and parameters exchanged for communication between the AIoTF 208 and the NG-RAN 204 regardless of the path to access the NG-RAN 204. Alternative examples of the following may be implemented, where some processes are performed in a different order than described or are not performed. In some cases, processes may include additional features not mentioned below, or further processes may be added.

At step 216, the AF 214 may output (e.g., transmit), and the NEF 212 may obtain (e.g., receive), a command request. The command request may be an Nnef_AIoT_Command request, which may include one or more of: an AF ID, a command type, information about one or more target AIoT device(s), an external target area information, an approximate (e.g., estimated) number of AIoT devices, an approximate (e.g., estimated) D2R message size, one or more command type specific parameters, location information requested by the AF 214. Information associated with the one or more target AIoT device(s) may include filtering information and/or may include complete AIoT device identifier(s). The approximate number of AIoT devices, if provided, may be used to indicate a number of AIoT devices expected to respond to this AIoT service operation request (e.g., command request), which is transmitted by the AIoTF 208 to the NG-RAN 204 in assistance information. The command type indicates the operation (e.g., read, write, etc.) to be performed and the command type specific parameters identify the required parameters for the operation.

At step 218, the NEF 212 may process external target area information and select the AIoTF 208 for the command request. If selecting the AIoTF 208 fails (e.g., unsuccessful selects an AIoTF 208), the NEF 212 may reject the command request (e.g., the Nnef_AIoT_Command request), and at step 226 the NEF 212 may output (e.g., transmit), and the AF 214 may receive, a command response.

At step 220, the NEF 212 may output (e.g., transmit), and the selected AIoTF 208 may obtain (e.g., receive), a command request (e.g., an Naiotf_AIoT_Command request message), which may include one or more of: an AF ID, a command type, information associated with one or more target AIoT device(s), an external target area information, an approximate (e.g., estimated) number of AIoT devices, an approximate (e.g., estimated) D2R message size, one or more command type specific parameters, location information requested).

At step 222, the AIoTF 208 may receive the Naiotf_AIoT_Command request message and checks the parameters included in the request. The AIoTF 208 may perform a reader selection. If no NG-RAN 204 or RAN Reader can be selected, the AIoTF 208 may reject the AIoT command request with an appropriate cause code. The AIoTF 208 may generate a correlation ID corresponding to this AIoT service operation request and the correlation ID is used for the AIoTF 208 to correlate the service operation responses received from the NG-RAN 204 to the request. The AIoTF 208 may create an AIoT session for the AF 214 service operation request, which is identified by the correlation ID. The AIoTF 208 may determine assistance information, taking into account the parameters provided in the AIoT service operation request. The AIoTF 208 performs AF authorization for the AIoT service operation request. The AIoTF 208 may performs AMF selection.

At step 224, the AIoTF 208 may send an Naiotf_AIoT_Command response message (e.g., including an accept or reject and/or a cause code) to the NEF 212.

At step 226, the NEF 212 may send an Nnef_AIoT_Command response message (e.g., including an accept or reject and/or a cause code) to the AF 214. If the response was a reject the procedure stops here.

At steps 228 to 238, the following may apply. In step 228, the AIoTF 208 may include follow on command indication in an inventory request message to inform the NG-RAN 204 that command delivery occurs after the inventory. Additionally, the AIoTF 208 may include in the inventory request message a type of a follow on command (e.g., an AIoT NAS message type) to be included in the paging message. In step 232, the RAN reader(s) include the type of the follow on command (e.g., an AIoT NAS message type) in the paging message. If an AIoT device matches the AIoT identification information in the paging message, it may further verify whether it can support the specified follow on command type. If the AIoT device is not able to support the specified follow on command type it may, based on configuration, either not respond to the paging message (e.g., refrain from transmitting an inventory report message, skipping transmitting the inventory report message, etc.), or respond to the paging with an AIoT NAS message that additionally includes an indication that the follow on command type is not supported. If the AIoT device is able to support the specified follow on command type, it may respond to the paging message with an AIoT NAS message and, based on configuration, includes an additional indication in the AIoT NAS message that the follow on command type is supported. In step 234, the NG-RAN 204 also may include the RAN AIoT device NGAP ID for each AIoT device in the inventory report. In step 236, the AIoTF 208 may validate the results, and may determine whether the command should be sent to an AIoT device (e.g., by checking the target AIoT device information and the device indication of follow on command type support). The AIoTF 208 may update the corresponding AIoT device context in the AIoTF 208 to include the RAN AIoT device NGAP ID.

If no successful inventory response is received, steps 230 to 236 are not performed and the AIoTF 208 may send a failure report to the NEF 212 in step 238.

At step 230, for each successful inventory report received, the AIoTF 208 may send a command request message (e.g., including: correlation ID, reader ID, NAS command request, approximate D2R message size, RAN AIoT device NGAP ID for each AIoT Device) to the NG-RAN 204 directly or as a NGAP AIoT information via an AMF 206. The NAS command request message may include the AIoT data. The correlation ID is as the same as the correlation ID generated in step 222. The RAN AIoT device NGAP ID for each AIoT device may be used by the NG-RAN 204 to determine the AIoT device context in the NG-RAN 204. The AIoTF 208 may use the command type and command type specific parameters received in step 220 to determine the NAS command Request to send to the AIoT device 202. Command request(s) can be sent to the NG-RAN 204 when the inventory procedure is ongoing.

At step 232, the NG-RAN 204 may send an AS R2D message (e.g., NAS command request) to the AIoT device 202.

At step 234, the AIoT device 202 may send an AS D2R message (e.g., NAS command response) to the NG-RAN 204. The NAS command response message may include the AIoT data.

At step 236, the NG-RAN 204 may respond with a command response message (e.g., including: correlation ID, reader ID, NAS command response, RAN AIoT device NGAP ID) to the AIoTF 208 directly or as a NGAP AIoT information via an AMF 206. The AIoTF 208 may determine the AIoT device 202 context by the RAN AIoT device NGAP ID received.

At step 238, the AIoTF 208 may report the result of the AIoT command request to the NEF 212 by sending an Naiotf_AIoT_Command notify message (e.g., including a list of AIoT device(s) response information (e.g., AIoT device ID(s), AIoT data, and/or location of each AIoT Device), AF ID, last report indication). When the last report is sent, the AIoTF 208 may end the AIoT session. If multiple AIoTFs are involved in the procedure, the NEF 212 may receive Naiotf_AIoT_Command Notify messages from multiple AIOTFs. Based on operator policy, if the location information is requested by the AF 214 and if the location of the reader is configured, the AIoTF 208 uses the reader ID reported from NG-RAN 204 during inventory in step 228 to determine the AIoT device Location.

At step 240, the NEF 212 may inform the AF 214 of the result of the Naiotf_AIoT_Command request by sending an Nnef_AIoT_Command notify message (e.g., including: a list of AIoT device(s) response information (e.g., AIoT device ID(s), AIoT data, and/or location of each AIoT Device), AF ID, last report indication).

In an Naiotf_AIoT_Notify service operation, the AIoTF 208 may use this service operation to notify the results or status of the service operation towards the NF consumers. If the NF consumer invokes the Naiotf_AIoT_Inventory, or Naiotf_AIoT_Command service operation, the NF consumer implicitly subscribes to the results of the requested service operation. For this operation, required inputs may include common report information such as a transaction ID. Moreover, optional inputs may include: a list of AIoT device IDs, follow on command type support, and/or failure cause in case of failure; read command specific report information-information obtained from each target AIoT device corresponding to each reported AIoT device ID; the last report indication indicating the notify is the last notify for an AIoT service operation; and/or location information of each AIoT Device. Further, required outputs may include an operation execution result indication.

In some configurations, an inventory procedure is used to discover one or more AIoT devices. If the AIoT identification information is not provided to the NG-RAN 204, all the AIoT devices are to be discovered. In this case, an indication from lower layer is provided. If the AIoT identification information is provided to the NG-RAN 204 and the AIoT identification information includes the filtering information, a group of AIoT devices that matches the AIoT identification information are to be discovered. If the AIoT identification information is provided to the NG-RAN 204 and the AIoT identification information includes an AIoT device identifier, a specific AIoT device that matches the AIoT identification information is to be discovered. If a follow on command type is provided to the NG-RAN 204, AIoT devices that support the specified follow on command type are to be discovered, either independently or in combination with AIoT identification information.

In certain configurations, to initiate an inventory procedure, the AIoTF 208 sends an inventory request to the selected NG-RAN 204. The selected NG-RAN 204 performs the AIoT paging by broadcast of the paging message that includes the AIoT identification information received in the inventory request.

In various configurations, the AIoTF 208 sends an AIoT paging request to the NG-RAN 204, the NG-RAN 204 sends an AIoT paging to the AIoT device 202, and the AIoT device 202 sends an inventory report to the AIoTF 208. Upon receiving a paging message, the lower layers of the AIoT device 202 determines whether to respond to the paging message. The evaluation in lower layers includes interaction with upper layers to assess AIoT identification information and/or the follow on command type, if included in the paging message. If lower layers determine to respond to the paging message, an indication is provided to upper layers.

For inventory procedure completion, the AIoT device 202 may determine to respond to the AIoT paging: based on an indication from a lower layer; based on whether a follow on command received from the lower layer is supported, when no AIoT identification information is provided; based on whether the AIoT identification information received from the lower layer is matched, when no follow on command type is provided; based on whether the AIoT identification information received from the lower layer is matched, and based on configuration, the follow on command type is not used to determine the paging response; or based on whether the AIoT identification is matched and the follow on command type is supported as received from the lower layer.

If the AIoT device 202 determines to respond to the AIoT paging, the AIoT device 202 may send an INVENTORY REPORT message to the AIoTF 208. The AIoT device 202 may derive a RANDAIOT_d value and may include the derived RANDAIOT_d value in the in the RANDAIOT_d IE in the INVENTORY REPORT message. The AIoT device 202 may derive a RESAIOT value, using the long-term configured KAIoT and the value of the RANDAIOT_n included in the paging message provided by lower layers. The derived RESAIOT value may be included in the in the RESAIOT IE in the INVENTORY REPORT message. The AIoT device 202 may include the AIoT device identity IE in the INVENTORY REPORT message.

The AIoT device 202 may determine whether the AIoT identification information is matched or not as follows: a) if the AIoT identification information includes an AIoT device identifier: b) if the AIoT identification information includes filtering information: 1) based on an ID type field included in the filtering information, the AIoT device determines the AIoT identification information is matched if: A) the PLMN ID field is not included in the filtering information, or the PLMN ID field is included in the filtering information and: i) the PLMN ID field is included in the AIoT device permanent identifier; and ii) the PLMN ID field in the AIoT device permanent identifier is the same as the PLMN ID field within the filtering information; B) the NID field is not included in the filtering information, or the NID field is included in the filtering information and: i) the NID field is included in the AIoT device permanent identifier; and ii) the NID field in the AIoT device permanent identifier is the same as the NID field within the filtering information; C) the third party ID field is not included in the filtering information, or the third party ID field is included in the filtering information and: i) the third party ID field is included in the AIoT device permanent identifier; and ii) the third party ID field in the AIoT device permanent identifier is the same as the third party ID field within the filtering information; and D) the identification information filters field is not included in the filtering information, or the identification information filters field is included in the filtering information and for each identification information filter, the component value within the identification information filter is the same as the corresponding bitstring from the AIoT device permanent identifier based on offset field and length field; or 2) otherwise, the AIoT device 202 determines the AIoT identification information is not matched. The AIoT identification information corresponds to paging ID.

Based on whether the AIoT identification information is matched: a) if the AIoT identification information is matched, the AIoT device 202 shall indicate to the lower layer that the AIoT identification information is matched, and determine to respond to the AIoT paging; or b) otherwise, the AIoT device 202 shall ignore the AIoT identification information, indicate to the lower layer that the filtering information is not matched, and determine not to respond to the AIoT paging.

The AIoT device 202 may determine whether the follow on command type received from the lower layer is supported by comparing the value of the follow on command type against the supported message types for the AIoT device 202 for the AIoTF 208 to AIoT device direction. The AIoT device 202 may, based on configuration, include the follow on command support IE in the INVENTORY REPORT message. If the follow on command type is supported the AIoT device 202 sets the value of the follow on command support IE to “supported”. If the follow on command type is not supported the AIoT device 202 sets the value of the follow on command support IE to “not supported”. Upon all the selected NG-RAN indicating the inventory procedure has been completed, the inventory procedure is considered as completed by the AIoTF 208.

In some configurations, an INVENTORY REPORT message is sent by the AIoT device 202 to the AIoTF 208 to report the AIoT device identity. Table 2 shows one example of contents of the INVENTORY REPORT.

TABLE 2
INVENTORY REPORT message content

| IEI | Information Element | Type/Reference | Presence | Format | Length |
|---|---|---|---|---|---|
| | Message type | Message type | M | V | 1 |
| | Security parameters | Security parameters | M | V | n |
| | RAND_{AIOT}_{_{—}}_{d} | RAND | M | V | TBD |
| | RES_{AIOT} | Authentication response | M | V | TBD |
| | | parameter | | | |
| | AIoT device identity | AIoT device identity | M | V | n |
| | Follow on command type | Follow on command type | O | V | 1 |
| | support | support | | | |

In certain configurations, the follow on command type support is a field of 1 octet length that indicates the AIoT device 202 support for the follow on command type provided by the network in the inventory request message as shown in Table 3.

TABLE 3
Follow on Command Type Support (octet 1)

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 0 | Not supported |
| 0 | 0 | 0 | 0 | 0 | 0 | 0 | 1 | Supported |

All other values are spare and if received shall be interpreted as “Not supported”.

Table 4 illustrates one example of a definition of type DevicesRepInfo that the AIoTF 208 may include in the Naiotf_AIoT_Command notify message in step 238.

TABLE 4
Definition of type DevicesRepInfo

| | | | | | |
|---|---|---|---|---|---|
| Attribute name | Data type | P | Cardinality | Description | Applicability |

| | | | | |
|---|---|---|---|---|
| deviceId | AiotDevPermId | M | 1 | Contains the identifier of the |
| | | | | AIoT device to which the |
| | | | | reporting information is |
| | | | | related. |
| cmdSupportInd | boolean | O | 0 . . . 1 | When present, this field |
| | | | | contains an indication from |
| | | | | the AIoT Device regarding |
| | | | | support for the follow-on |
| | | | | command. |
| | | | | “true” indicates that the |
| | | | | follow-on command is |
| | | | | supported. |
| | | | | “false” indicates that the |
| | | | | follow-on command is not |
| | | | | supported. |
| readCmdRep | Bytes | O | 0 . . . 1 | Contains the Read command |
| | | | | specific report information |
| | | | | for the AIoT device |
| | | | | identified by the “deviceId” |
| | | | | attribute. |
| | | | | This attribute may be present |
| | | | | only if the reporting |
| | | | | information is related to a |
| | | | | Read command operation, |
| | | | | i.e., the “commandType” |
| | | | | attribute is set to “READ” in |
| | | | | the corresponding AIoT |
| | | | | Command service operation. |

In some systems, an AIoT paging procedure may be used is to transmit AIoT paging messages to one or more devices. The reader may include the paging ID field to select a specific device or a group of devices, or may not include paging ID field to select all devices. Additionally, the reader may include the follow on command type field to indicate the type of the AIOT NAS message that the upper layers intend to send to the device in a subsequent R2D upper layer data transfer message. The device may always monitor for the AIoT paging message, and may determine whether the device is selected to initiate the access procedure.

Upon receiving the AIoT paging message, an AIoT MAC entity may do the following:
1> if the Access Type field in the A-IoT Paging message indicates CBRA:
2> if the device has no stored Transaction ID; or
2> if the value of the Transaction ID field is different from the stored Transaction ID; or
2> if the value of the Transaction ID field is the same as the stored Transaction ID, and the previous procedure was determined as failed for this Transaction ID:
3> release the stored AS ID, if any;
3> store the received value in Transaction ID field, if the device has no stored Transaction ID, or replace the previously stored Transaction ID with the current received value, if the value of the Transaction ID field is different from the stored Transaction ID;
3> if the Paging ID Presence Indication field indicates Paging ID field is absent and the Follow on Command type Presence Indication field indicates Follow on Command type field is absent:
4> consider the device is selected and indicate it to the upper layers;
3> else:
4> forward the content of the Paging ID field and/or the content of the Follow on Command type field to the upper layers;
4> if the upper layers indicate that the Paging ID is matched and/or the Follow on Command type is supported:
5> consider the device is selected;
3> if the device is selected:
4> initiate Contention-Based Random Access procedure;
1> else (i.e., the Access Type field in the AIoT Paging message indicates CFA):
2> release the stored AS ID, if any;
2> release the stored Transaction ID, if any;
2> forward the content of the Paging ID field and/or the content of the Follow on Command type field to the upper layers;
2> if the upper layers indicate that this Paging ID is matched and/or the Follow on Command type is supported:
3> consider the device is selected;
3> initiate Contention-Free Access procedure.

Tables 5 and 6 show examples of formats of an AIoT paging message. The fields shown in Tables 5 and 6 may be defined as follows. R2D Message Type: this field indicates the message type—the length of the field is 3 bits. R2D transport block size (TBS): this field indicates the TBS of this message. The value can be {1, 2, . . . , 124, 125} byte(s)—the length of the field is 7 bits. Access type (AT): this field indicates contention based random access (CBRA) (when set to 1) or contention-free access (CFA) (when set to 0)—the length of the field is 1 bit.

For CBRA, the following fields are further included: transaction ID: this field associates an inventory procedure or command procedure—the length of the field is 6 bits; paging ID presence indication (PIPI): this field indicates whether paging ID and length of paging ID fields are present (when set to 1) or absent (when set to 0)—the length of the field is 1 bit; paging ID length: this field indicates the length of the paging ID field in unit of bits when paging ID field is present-if present, the length of the field is 8 bits; paging ID: if present, this field contains AIoT identification information—this field is of variable length; follow on command type presence indication (FCPI): this field indicates whether the follow on command type field is present (when set to 1) or absent (when set to 0)—the length of the field is 1 bit; follow on command type: if present, this field contains the AIoT NAS message type; number of access occasions: this field indicates the number of access occasions—the length of the field is 4 bits. The value 0 (i.e., 0000) indicates the number of access occasions is 20. The value 1 (i.e., 0001) indicates the number of access occasions is 21. The value 2 (i.e., 0010) indicates the number of access occasions is 22. And so on. The maximum number of access occasions is 215 when this field is set to 15 (i.e., 1111); D2R scheduling info: this field contains the physical layer parameters used for D2R transmission. The length of the field is 18 bits. K: this field indicates that the value K is 1 (when set to 0) or 4 (when set to 1) used for determining monitor window for random ID response message—the length of the field is 1 bit; fill bits: this field is of variable size and is optionally present. It can be used to pad for byte alignment (1-7 bits) and/or contain future extensions. The MAC entity may ignore the values of this field.

For CFA, the following fields are further included: paging ID length: this field indicates the length of the paging ID field in unit of bit—the length of the field is 8 bits; paging ID: this field contains AIOT identification information—this field is of variable length; FCPI: this field indicates whether the follow on command type field is present (when set to 1) or absent (when set to 0)—the length of the field is 1 bit; follow on command type: if present, this field contains the AIOT NAS message type; D2R scheduling Info: this field contains the physical layer parameters used for D2R transmission—the length of the field is 24 bits; fill bits: this field is of variable size, and can be used to pad for byte alignment (1-7 bits) and/or contain future extensions. The MAC entity may ignore the values of this field.

TABLE 5
MAC PDU of AIoT Paging Message Indicating CBRA

| R2D Message Type | | R2D TBS |
|---|---|---|
| R2D TBS | AT = 1 | Transaction ID (TXID) |

| | | |
|---|---|---|
| TXID | PIPI | Paging ID Length (PIDL) |

| | |
|---|---|
| PIDL | Paging ID |

Paging ID

| | |
|---|---|
| FCPI | Follow on Command Type |

| | |
|---|---|
| Number of Access Occasions | D2R Scheduling Info |

D2R Scheduling Info

| | | |
|---|---|---|
| D2R Scheduling Info | K | Fill |

Bits

TABLE 6
MAC PDU of AIoT Paging Message Indicating CFA

| R2D Message Type | | | R2D TBS |
|---|---|---|---|
| | R2D TBS | AT = 0 | Paging ID Length (PIDL) |

| | |
|---|---|
| PIDL | Paging ID |

Paging ID

| | | |
|---|---|---|
| Paging ID | FCPI | Follow on Command Type |

| | |
|---|---|
| Follow on Command | D2R Scheduling Info |

Type

D2R Scheduling Info
D2R Scheduling Info

| | |
|---|---|
| D2R Scheduling Info | Fill Bits |

In certain configurations, there may be an NGAP Inventory Request message that includes inventory request transfer information. In such configurations, an IE provides inventory request related information from the AIoTF 208 to the NG-RAN 204. In indirect communication, this IE is transparent to the AMF 206. Table 7 shows information related to an inventory request transfer.

TABLE 7
Inventory Request Transfer Information

| | Group Name | | | | | |
|---|---|---|---|---|---|---|
| | | | IE type and | Semantics | | Assigned |
| IE | Presence | Range | reference | description | Criticality | Criticality |
| A-IoT Correlation | M | | 9.3.3.xx1 | | YES | reject |
| Identifier | | | | | | |
| A-IoT Device | M | | 9.3.3.xx5 | | YES | reject |
| Identification | | | | | | |
| Requested | | | | | | |
| Requested Service | M | | 9.3.3.xx3 | | YES | reject |
| Area Information | | | | | | |
| Inventory Assistance | M | | 9.3.3.xx4 | | YES | Reject |
| Information | | | | | | |
| Follow on Command | O | | ENUMERATED | This IE indicates | YES | Reject |
| Indication | | | (true, . . . ) | that there is | | |
| | | | | command(s) | | |
| | | | | to be transmitted. | | |
| Follow on Command | O | | INTEGER | This IE indicates | YES | reject |
| type | | | | the the A-IoT | | |
| | | | | NAS message type | | |
| | | | | of the command(s) | | |
| | | | | to be transmitted. | | |

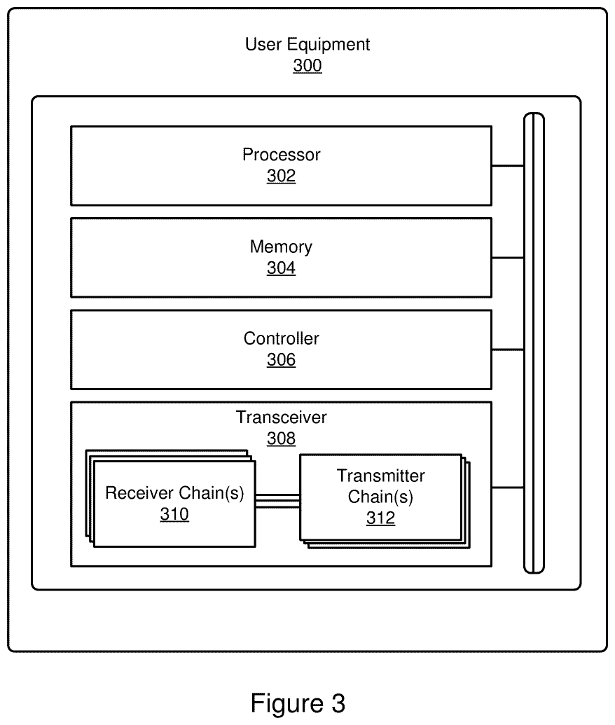

FIG. 3 illustrates an example of a UE 300 in accordance with aspects of the present disclosure. The UE 300 may include a processor 302, a memory 304, a controller 306, and a transceiver 308. In some instances, the UE 300 may include more or fewer components. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302 cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. For example, the processor 302 coupled with the memory 304 may be configured to cause the UE 300 to: receive an inventory request message, wherein the inventory request message comprises a command type; determine whether the UE 300 supports the command type; and determine whether to transmit an inventory report message in response to the received inventory request message and based at least in part on whether the UE 300 supports the command type. In another example, the UE 300 may be a more simplified device that has ultra-low complexity, non-registered, passive or semi-passive device (e.g., AIoT device), a processor coupled with a memory may be configured to cause the AIoT device to: receive an inventory request message, wherein the inventory request message comprises a command type; determine whether the AIoT device supports the command type; and determine whether to transmit an inventory report message in response to the received inventory request message and based at least in part on whether the AIoT device supports the command type.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receive the signal over the air or wireless medium. The receiver chain 310 may include at least one amplifier (e.g., a low-noise amplifier (LNA)) configured to amplify the received signal. The receiver chain 310 may include at least one demodulator configured to demodulate the receive signal and obtain the transmitted data by reversing the modulation technique applied during transmission of the signal. The receiver chain 310 may include at least one decoder for decoding the processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like PSK or QAM. The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

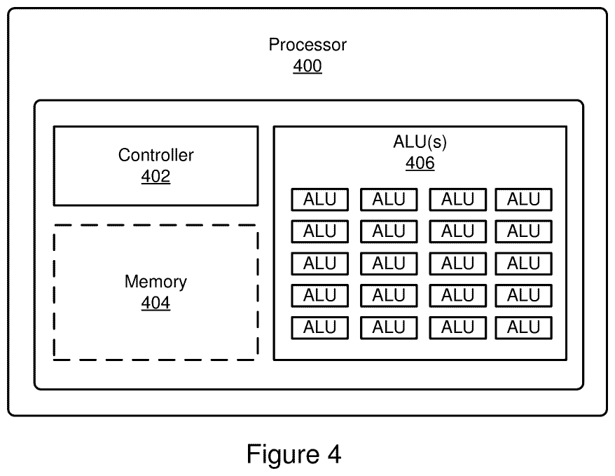

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support a means for performing various operations described herein. For example, the processor 400 may be configured to: receive an inventory request message, wherein the inventory request message comprises a command type; determine whether the IoT device supports the command type; and determine whether to transmit an inventory report message in response to the received inventory request message and based at least in part on whether the IoT device supports the command type.

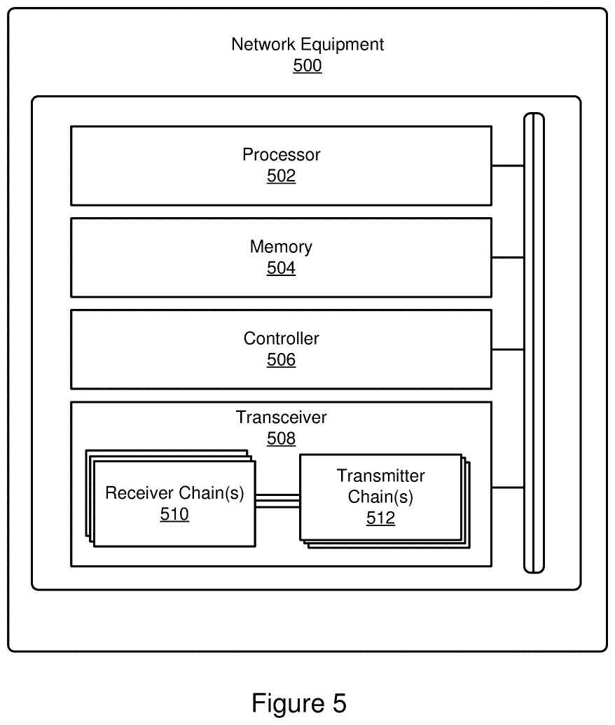

FIG. 5 illustrates an example of an NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an ASIC, or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure. For example, the processor 502 coupled with the memory 504 may be configured to cause the NE 500 to: transmit an inventory request message to an IoT device, wherein the inventory request message comprises a command type; monitor for an inventory report message from the IoT device based at least in part on the transmitted inventory request message, wherein the inventory report message comprises an indication that is indicative of whether the command type is supported by the IoT device; and determine a capability of the IoT device in response to a reception of the inventory report message based at least in part on the monitoring or an absence of the inventory report message from the IoT device based at least in part on the monitoring.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

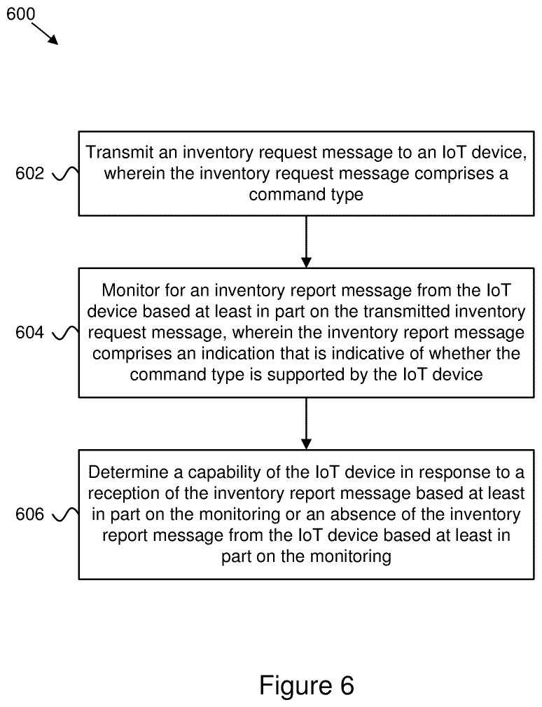

FIG. 6 illustrates a flowchart of a method 600 in accordance with aspects of the present disclosure. The operations of the method 600 may be implemented by an NE. In some implementations, the NE may execute a set of instructions to control the function elements of a processor to perform the described functions. It should be noted that the method described herein describes a possible implementation, and that the operations and the steps may be rearranged or otherwise modified and that other implementations are possible.

At 602, the method may include transmitting an inventory request message to an IoT device, wherein the inventory request message comprises a command type. The operations of 602 may be performed in accordance with examples as described herein. In some implementations, aspects of the operations of 602 may be performed by an NE as described with reference to FIG. 5.

At 604, the method may include monitoring for an inventory report message from the IoT device based at least in part on the transmitted inventory request message, wherein the inventory report message comprises an indication that is indicative of whether the command type is supported by the IoT device. The operations of 604 may be performed in accordance with examples as described herein. In some implementations, aspects of the operations of 604 may be performed by an NE as described with reference to FIG. 5.

At 606, the method may include determining a capability of the IoT device in response to a reception of the inventory report message based at least in part on the monitoring or an absence of the inventory report message from the IoT device based at least in part on the monitoring. The operations of 606 may be performed in accordance with examples as described herein. The operations of 606 may be performed in accordance with examples as described herein. In some implementations, aspects of the operations of 606 may be performed by an NE as described with reference to FIG. 5.

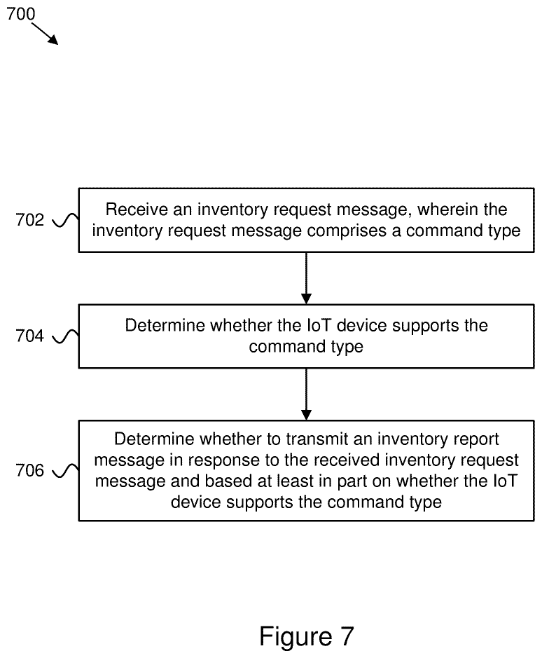

FIG. 7 illustrates a flowchart of a method 700 in accordance with aspects of the present disclosure. The operations of the method 700 may be implemented by a UE (e.g., IoT device) as described herein. In some implementations, the UE may execute a set of instructions to control the function elements of a processor to perform the described functions. It should be noted that the method described herein describes a possible implementation, and that the operations and the steps may be rearranged or otherwise modified and that other implementations are possible.

At 702, the method may include receiving an inventory request message, wherein the inventory request message comprises a command type. The operations of 702 may be performed in accordance with examples as described herein. In some implementations, aspects of the operations of 702 may be performed by a UE as described with reference to FIG. 3.

At 704, the method may include determining whether the IoT device supports the command type. The operations of 704 may be performed in accordance with examples as described herein. In some implementations, aspects of the operations of 704 may be performed by a UE as described with reference to FIG. 3.

At 706, the method may include determining whether to transmit an inventory report message in response to the received inventory request message and based at least in part on whether the IoT device supports the command type. The operations of 706 may be performed in accordance with examples as described herein. In some implementations, aspects of the operations of 706 may be performed by a UE as described with reference to FIG. 3.

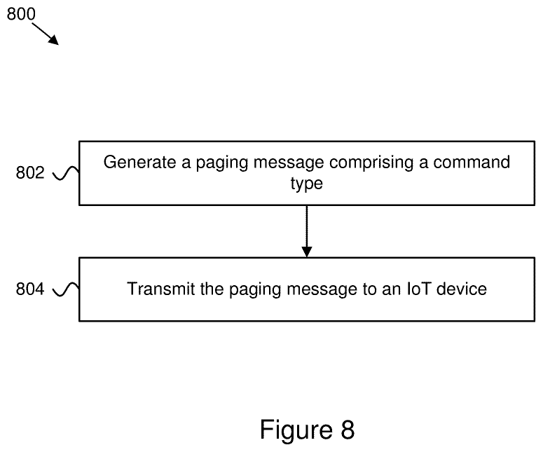

FIG. 8 illustrates a flowchart of a method 800 in accordance with aspects of the present disclosure. The operations of the method 800 may be implemented by an NE. In some implementations, the NE may execute a set of instructions to control the function elements of a processor to perform the described functions. It should be noted that the method described herein describes a possible implementation, and that the operations and the steps may be rearranged or otherwise modified and that other implementations are possible.

At 802, the method may include generating a paging message comprising a command type. The operations of 802 may be performed in accordance with examples as described herein. In some implementations, aspects of the operations of 802 may be performed by an NE as described with reference to FIG. 5.

At 804, the method may include transmitting the paging message to an IoT device. The operations of 804 may be performed in accordance with examples as described herein. In some implementations, aspects of the operations of 804 may be performed by an NE as described with reference to FIG. 5.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
at least one memory; and
at least one processor coupled with the at least one memory and configured to cause the network entity to:
transmit an inventory request message to an internet of things (IoT) device, wherein the inventory request message comprises a command type;
monitor for an inventory report message from the IoT device based at least in part on the transmitted inventory request message, wherein the inventory report message comprises an indication that is indicative of whether the command type is supported by the IoT device; and
determine a capability of the IoT device in response to a reception of the inventory report message based at least in part on the monitoring or an absence of the inventory report message from the IoT device based at least in part on the monitoring.

2. The network entity of claim 1, wherein the at least one processor is configured to cause the network entity to:
receive the inventory report message including the indication that is indicative of whether the command type is supported by the IoT device,
wherein determining the capability of the IoT device is based at least in part on the indication that is indicative of whether the command type is supported by the IoT device.

3. The network entity of claim 1, wherein the inventory request message is transmitted during a command procedure, the at least one processor is configured to cause the network entity to:
terminate the command procedure based at least in part on the capability of the IoT device, wherein the capability of the IoT device lacks support for the command type.

4. The network entity of claim 1, wherein the at least one processor is configured to cause the network entity to:
determine, based at least in part on the monitoring, the absence of reception of the inventory report message from the IoT device within a threshold duration,
wherein the absence of reception of the inventory report message from the IoT device within the threshold duration is indicative that the command type is unsupported by the IoT device.

5. The network entity of claim 1, wherein the inventory report message further comprises an error cause, and wherein a value of the error cause is indicative of one or more of the command type being unsupported by the IoT device or an energy budget of the IoT device being less than or equal to a threshold energy budget.

6. The network entity of claim 1, wherein the inventory report message comprising the indication is received as part of a INVENTORY REPORT AIOT NAS message.

7. The network entity of claim 1, wherein the inventory request message comprises a next generation application protocol (NGAP) INVENTORY REQUEST message.

8. The network entity of claim 1, wherein the inventory request message is part of a medium access control (MAC) protocol data unit (PDU) of a paging message for IoT.

9. The network entity of claim 1, wherein the command type is one or more of integrity protected or confidentiality protected.

10. The network entity of claim 1, wherein the inventory request message is transmitted to a user equipment (UE) or a radio access network (RAN) configured to relay the inventory request message to the IoT device.

11. The network entity of claim 1, wherein the at least one processor is configured to cause the network entity to:
determine that the command type is unsupported by the IoT device based at least in part on the absence of the inventory report message from the IoT device or in response to the indication indicating that the command type is unsupported; and
transmit information to a second network entity indicating the command type is unsupported by the IoT device,
wherein the network entity is an ambient IoT function (AIoTF), and wherein the second network entity is an application function (AF) or a network exposure function (NEF).

12. A method for wireless communication performed by a network entity, the method comprising:
transmitting an inventory request message to an internet of things (IoT) device, wherein the inventory request message comprises a command type;
monitoring for an inventory report message from the IoT device based at least in part on the transmitted inventory request message, wherein the inventory report message comprises an indication that is indicative of whether the command type is supported by the IoT device; and
determining a capability of the IoT device in response to a reception of the inventory report message based at least in part on the monitoring or an absence of the inventory report message from the IoT device based at least in part on the monitoring.

13. An internet of things (IoT) device, comprising:
at least one memory; and
at least one processor coupled with the at least one memory and configured to cause the IoT device to:
receive an inventory request message, wherein the inventory request message comprises a command type;
determine whether the IoT device supports the command type; and
determine whether to transmit an inventory report message in response to the received inventory request message and based at least in part on whether the IoT device supports the command type.

14. The IoT device of claim 13, wherein the at least one processor is configured to cause the IoT device to:
refrain from transmitting the inventory report message in response to the received inventory request message and based at least in part on determining that the command type is unsupported by the IoT device.

15. The IoT device of claim 13, wherein the at least one processor is configured to cause the IoT device to:
transmit the inventory report message in response to the received inventory request message and based at least in part on determining that the command type is supported by the IoT device,
wherein the inventory report message comprises an indication that is indicative of whether the command type is supported by the IoT device.

16. The IoT device of claim 15, wherein the inventory report message further comprises an error cause, and wherein a value of the error cause is indicative of one or more of the command type being unsupported by the IoT device or an energy budget of the IoT device being less than or equal to a threshold energy budget.

17. The IoT device of claim 15, wherein the inventory report message comprising the indication is transmitted as part of an INVENTORY REPORT AIOT NAS message.

18. The IoT device of claim 13, wherein the inventory request message comprises a medium access control (MAC) protocol data unit (PDU) of an AIoT paging message indicating contention-based random access (CBRA) or contention-free access (CFA).

19. The IoT device of claim 13, wherein the inventory request message is received from a user equipment (UE) configured to relay the inventory request message to the IoT device.

20. A radio access network (RAN) device, comprising:
at least one memory; and
at least one processor coupled with the at least one memory and configured to cause the RAN device to:
generate a paging message comprising a command type; and
transmit the paging message to an internet of thing (IoT) device.
